(19) United States
(12) Patent Application Publication
(10) Pub. No.: US 2010/0033363 A1
(43) Pub. Date: Feb. 11, 2010

(54) SHIP TRAFFIC CONTROL APPARATUS AND METHOD THEREOF

(75) Inventors: Hyung Kyu Lee, Daejeon (KR); Seoung Hyeon Lee, Daejeon (KR); Do-Woo Kim, Daejeon (KR); Jong-Wook Han, Daejeon (KR); Kyo Il Chung, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/476,915

(22) Filed: Jun. 2, 2009

(30) Foreign Application Priority Data
Aug. 5, 2008 (KR) 10-2008-0076475

(51) Int. Cl. G01S 13/93

(52) U.S. Cl. 342/41

(57) ABSTRACT

A ship traffic control apparatus includes a location recognizer for measuring a location coordinate of a ship by using a satellite location-based service; a ship identifier/location coordinate manager for storing the location coordinate as coordinate information corresponding to a ship identifier; an accident processing unit for providing an accident information when an accident occurs; and an operation controller for forming location information by mapping between the coordinate information and navigation information, transmitting the location information to other ships or a control system in a prescribed cycle through a radio communication unit, and transmitting accident occurrence information including the accident information and the location information to other ships or the control system.

### CROSS-REFERENCE(S) TO RELATED APPLICATION(S)

The present invention claims priority of Korean Patent Application No. 10-2008-0076475, filed on Aug. 5, 2008, which is incorporated herein by reference.

### FIELD OF THE INVENTION

The present invention relates to a ship traffic control technique, and in particular, to a ship traffic control apparatus and method thereof capable of transmitting location information including a location coordinate and a ship identifier of a ship, when an accident occurs while the location information is being transmitted, transmitting corresponding accident occurrence information, and storing and managing the location information and the accident occurrence information.

### BACKGROUND OF THE INVENTION

As well known in the art, with respect to a technology for ship operation, in 2006, E-navigation technology which is offered in union by the U.K., Japan, the U.S. and others was adopted as an agenda in the IMO (International Maritime Organization), and it was decided to establish specific concept, policy, vision, and the like of the technology by 2008. Accordingly, many studies and developments on electronic charts, intelligent integrated navigation systems, communication equipments, and the like are gradually making progress.

In Korea, in order to secure a safe ship traffic and promptly deal with accidents by monitoring the ship traffic in real-time, the Ships Safety Act prescribes that commercial ships above five tons and passenger ships with international service have to get position indicating System installed on board. In addition, a national crisis management system is being established for sharing maritime accident information among principal government agencies, such as NSC (National Security Council), NIS (National Intelligence Service), MOPAS (Ministry of Public Administration and Safety, KCG (Korea Coast Guard), and others.

Meanwhile, in conventional related arts, communication between ships and communication between a ship and a control system are performed by using Automatic Identification System (AIS) in coastal area, Single Side Band (SSB) or satellite in offshore area, and satellite in ocean area, depending on a type of a ship and a range of navigation.

However, with such communication methods between ships and between a ship and a control system, it is difficult to immediately cope with a disorder or accident of the ships on the sea. As a result, a smooth ship service encounters an obstacle.

### SUMMARY OF THE INVENTION

In view of the above, the present invention provides a ship traffic control apparatus and method thereof capable of cyclically measuring a location of a ship using a satellite location-based service with accuracy, storing location information, and cyclically broadcasting the location information to other ships or a control system.

Further, the present invention provides a ship traffic control apparatus and method thereof capable of, when an accident occurs in a state where cyclically measured location information is stored, immediately broadcasting accident occurrence information to other ships or a control system.

In accordance with an aspect of the present invention, there is provided a ship traffic control apparatus including:

a location recognizer for measuring a location coordinate of a ship by using a satellite location-based service;

a ship identifier/location coordinate manager for storing the location coordinate as coordinate information corresponding to a ship identifier;

an accident processing unit for providing an accident information when an accident occurs; and

an operation controller for forming location information by mapping between the coordinate information and navigation information, transmitting the location information to other ships or a control system in a prescribed cycle through a radio communication unit, and transmitting accident occurrence information including the accident information and the location information to other ships or the control system.

In accordance with another aspect of the present invention, there is provided a ship traffic control method including:

measuring a location coordinate of a ship in a prescribed cycle;

mapping the measured location coordinate to a ship identifier to form coordinate information;

mapping the coordinate information to navigation information to form location information of the ship; and

broadcasting the location information to other ships or a control system in a prescribed cycle through a radio communication unit.

### BRIEF DESCRIPTION OF THE DRAWINGS

The above features of the present invention will become apparent from the following description of embodiments, given in conjunction with the accompanying drawings, in which:

FIG. 1 is a block diagram of a ship traffic control apparatus in accordance with an embodiment of the present invention;

FIG. 2A is a diagram showing ship identifier information in accordance with the embodiment of the present invention;

FIG. 2B is a diagram showing navigation information in accordance with the embodiment of the present invention;

FIG. 2C is a diagram showing accident information in accordance with the embodiment of the present invention;

FIG. 3 is a flowchart showing a process for broadcasting ship location information in a prescribed cycle in accordance with the embodiment of the present invention;

FIG. 4 is a flowchart showing a process for receiving ship location information being broadcasted in a prescribed cycle and processing location information in accordance with the embodiment of the present invention;

FIG. 5 is a flowchart showing a process for broadcasting accident occurrence information when an accident occurs in accordance with the embodiment of the present invention; and

FIG. 6 is a flowchart showing a process for receiving accident occurrence information when an accident occurs and processing accident occurrence information in accordance with the embodiment of the present invention.

### DETAILED DESCRIPTION OF THE EMBODIMENTS

The technical gist of the present invention is as follows. First, a location coordinate of a ship is measured and detected in a prescribed cycle. The detected location coordinate is mapped to a ship identifier and then is mapped to navigation information. The resultant location information is displayed and also broadcasted to other ships and a control system. When an accident occurs while the location information is being broadcasted, a level of the accident is determined, and information of the accident is transmitted. The accident information is added to the location information, in which the location coordinate, the ship identifier, and the map information are mapped one another, and the accident occurrence information is broadcasted to other ships and the control system. Through this technical method, the drawbacks in the conventional arts can be resolved.

Hereinafter, embodiments of the present invention will be described in detail with reference to the accompanying drawings.

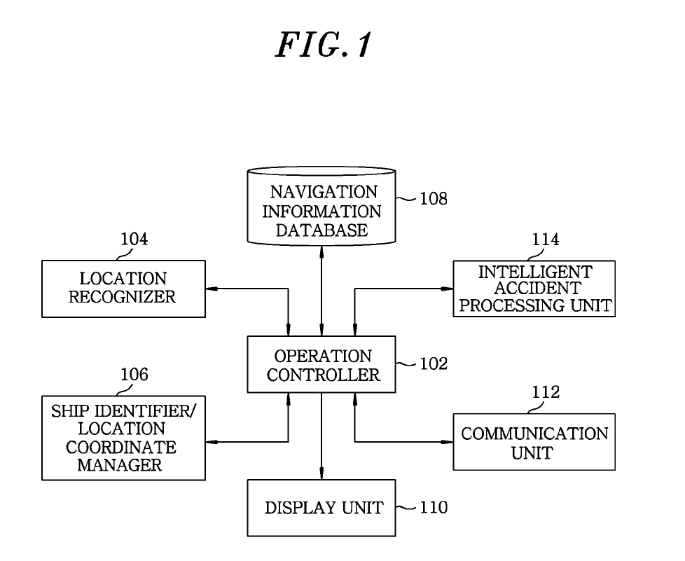

FIG. 1 is a block diagram of a ship traffic control apparatus in accordance with an embodiment of the present invention. The ship traffic control apparatus includes an operation controller 102, a location recognizer 104, a ship identifier/location coordinate manager 106, a navigation information database 108, a display unit 110, a communication unit 112, and an intelligent accident processing unit 114.

Referring to FIG. 1, the operation controller 102 controls overall operation of the ship traffic control apparatus. The operation controller 102 issues a control signal to measure and recognize a location of a ship by using a satellite location-based service (LBS) to the location recognizer 104, and provides a location coordinate transmitted from the location recognizer 104 to the ship identifier/location coordinate manager 106. The operation controller 102 also issues a display control signal for displaying the location information formed by mapping between coordinate information provided from the ship identifier/location coordinate manager 106 and navigation information (for example, navigation chart, canal map, destination, departure location, stopover place, speed, and the like) extracted from the navigation information database 108, to the display unit 110.

Further, the operation controller 102 issues a transmission control signal including the location information to the communication unit 112 so as to broadcast the location information in a prescribed cycle (for example, ten minutes, twenty minutes, or the like), and receives various kinds of information from other ships or the control system through the communication unit 112. The location information is stored in the ship identifier/location coordinate manager 106 and the navigation information database 108.

In addition, when an accident or a disorder of the ship occurs, the operation controller 102 receives accident information (for example, accident type, accident occurrence time, accident level, measures for other ships against accident, and the like) from the intelligent accident processing unit 114, and not only stores accident occurrence information formed by mapping between the accident information and the stored location information in the ship identifier/location coordinate manager 106 and the navigation information database 108 but also provides a transmission control signal including the accident occurrence information to the communication unit 112 so as to transmit the accident occurrence information to other ships or the control system.

The location recognizer 104 includes a location recognition module for the satellite location-based service (LBS). The location recognizer 104 measures a current location coordinate by using the satellite location-based service under the control of the operation controller 102, and transmits the current location coordinate to the operation controller 102. A measurement of the location coordinate may be performed in the prescribed cycle under the control of the operation controller 102.

The ship identifier/location coordinate manager 106 stores and manages the ship identifier, the location coordinate, and the like. More specifically, The ship identifier/location coordinate manager 106 stores and manages the location coordinate from the operation controller 102 in association with ship identifier information (for example, ship type, ship size, proprietary, ship ID, and the like) as the coordinate information (for example, ship type, ship size, proprietary, ship ID, location coordinate, and the like), and then stores the location information provided from the operation controller 102 corresponding to the coordinate information. Such stored information is extracted and provided to the operation controller 102 as occasion demands.

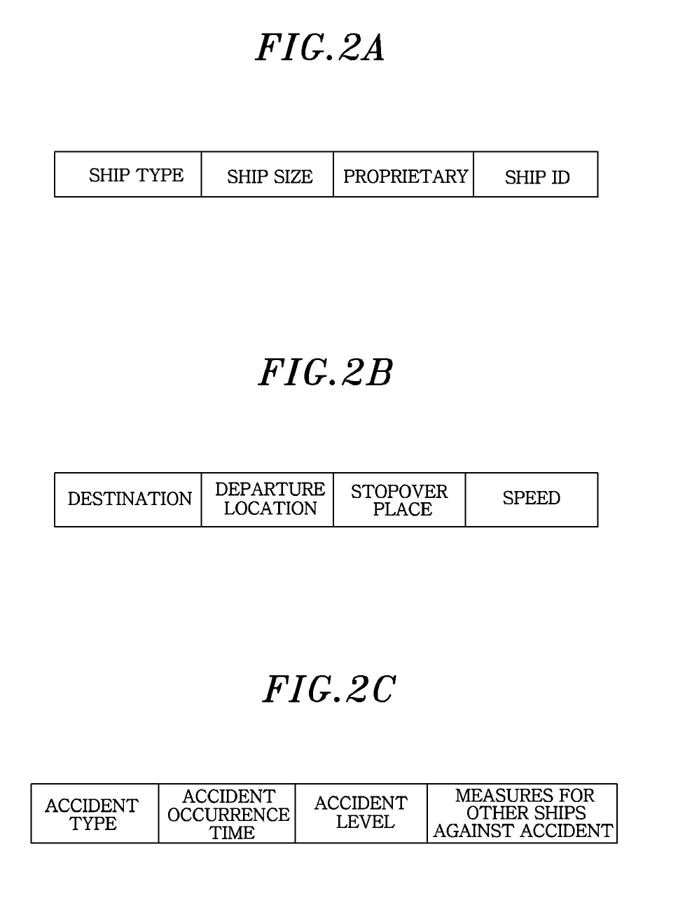

FIG. 2A is a diagram showing an example of ship identifier information. The ship identifier information includes table items, such as ship type, ship size, proprietary, ship ID, and the like. Here, the ship type may be classified into cruiser, freighter, leisure boat, and the like, the ship size may be classified into capacity (ton), deadweight capacity (ton), displacement (ton), and the like, and the proprietary may be classified into company, address, owner, and the like.

Moreover, the ship identifier/location coordinate manager 106 stores and manages accident occurrence information, which is formed by mapping between the accident information and the location information in the operation controller 102, corresponding to the coordinate information, the location information, and the like.

The navigation information database 108 manages database for the navigation information, such as navigation chart, canal map, destination, departure location, stopover place, speed, and the like. This navigation information is extracted from the navigation information database 108 and provided to the operation controller 102. Thereafter, the navigation information database 108 stores and manages the location information, which is formed by mapping between the navigation information and the coordinate information, from the operation controller 102, corresponding to the navigation information. When an accident occurs, the navigation information database 108 also stores and manages the accident occurrence information, which is formed by mapping between the accident information and the location information, corresponding to the navigation information.

FIG. 2B shows an example of the navigation information. As shown in FIG. 2B, the navigation information includes table items, such as destination, departure location, stopover place, speed, and the like, and such navigation information is stored in the navigation information database 108.

The display unit 110 includes various kinds of display devices, such as an LCD, an OLED, and the like. The display unit 110 processes and displays various kinds of video information provided from the operation controller 102. That is, the display unit 110 displays the location of a ship, the coordinate, the map, and the like on the basis of the location information provided from the operation controller 102, or displays the locations of an accident ship and other ships, the coordinate, the map, and the like on the basis of the accident occurrence information when the accident occurs.

The communication unit 112 includes a broadband radio communication module such as WiBro or the like, a VHF-band radio communication module, and the like, and performs communication with other ships or the control system. The communication unit 112 broadcasts the location information of the ship and, if the accident occurs, the accident occurrence information of the ship to other ships or the control system, in the prescribed cycle, in response to a broadcast control signal from the operation controller 102. Further, the communication unit 112 receives the location information and the accident occurrence information from other ships or the control system and transmits them to the operation controller 102.

The intelligent accident processing unit 114 determines accident occurrence on the basis of information measured by various measurement sensors and provides the operation controller 102 with the accident information. FIG. 2C shows an example of the accident information. As shown in FIG. 2C, the accident information includes table items, such as accident type, accident occurrence time, accident level, measures for other ships against accident, and the like. Here, the accident type may be classified into engine trouble, collision, operation control, accident settlement, and the like, and the accident occurrence time may be represented by, for example, the standard time (hour, minute, and second) or the like. The accident level may be classified into inoperable condition, slow speed-operable condition, medium speed-operable condition, normal operable condition, and the like, and the measures for other ships may be classified into careful operation, standby, normal operation, under control of the control center, and the like.

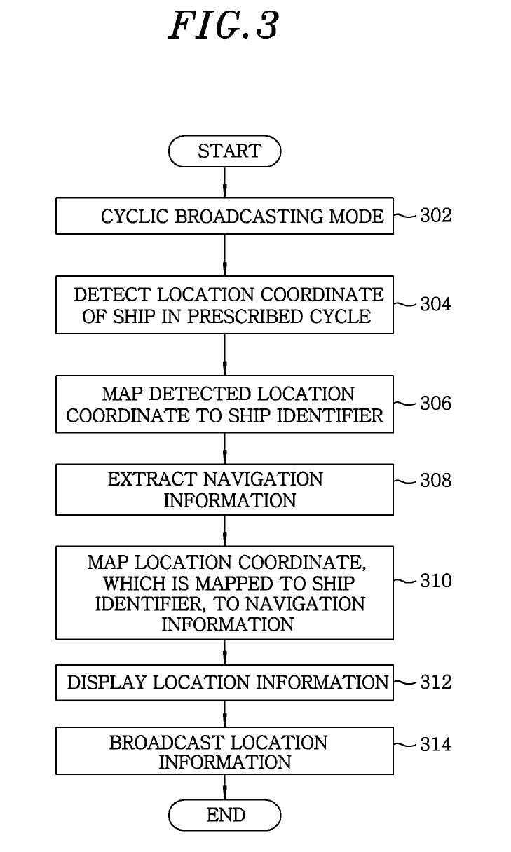

Hereinafter, operation process of the ship traffic control apparatus having the above-described configuration will be described with reference to FIG. 3 to FIG. 6.

FIG. 3 is a flowchart showing a process for broadcasting location information of a ship in a prescribed cycle in accordance with the embodiment of the present invention.

First, the ship traffic control apparatus performs a cyclic broadcasting mode in step 302. In the cyclic broadcasting mode of the ship traffic control apparatus, the operation controller 102 provides the location recognizer 104 with a control signal for measuring and detecting the location coordinate of the ship, in a prescribed cycle (for example, ten minutes, twenty minutes, or the like). The location recognizer 104 measures and detects location coordinate of the ship by using the satellite location-based service (LBS) or the like in response to the control signal, and transmits the location coordinate to the operation controller 102 and in turn to the ship identifier/location coordinate manager 106 in step 304.

The ship identifier/location coordinate manager 106, in step 306, maps the location coordinate to the ship identifier information, and transmits corresponding coordinate information to the operation controller 102. The ship identifier information may include, for example, ship type, ship size, proprietary, ship ID, and the like, and the corresponding coordinate information may include, for example, ship type, ship size, proprietary, ship ID, location coordinate, and the like.

When the coordinate information is transmitted from the ship identifier/location coordinate manager 106 to the operation controller 102, the operation controller 102 extracts navigation information, such as navigation chart, canal map, destination, departure location, stopover place, speed, and the like from the navigation information database 108 in step 308, and maps the navigation information to the coordinate information to form corresponding location information in step 310. The location information may include, for example, navigation chart, canal map, destination, departure location, stopover place, speed, ship type, ship size, proprietary, ship ID, location coordinate, and the like.

Next, in step 312, the operation control unit 102 provides the display unit 110 with a display control signal for displaying the location information. The display unit 110 then displays the location information on the related navigation chart in a superimposition manner in response to the display control signal.

Simultaneously, in step 314, the operation controller 102 provides the communication unit 112 with a broadcast control signal for broadcasting the location information to other ships or the control system. The communication unit 112 then broadcasts the location information to other ships or the control system in response to the broadcast control signal.

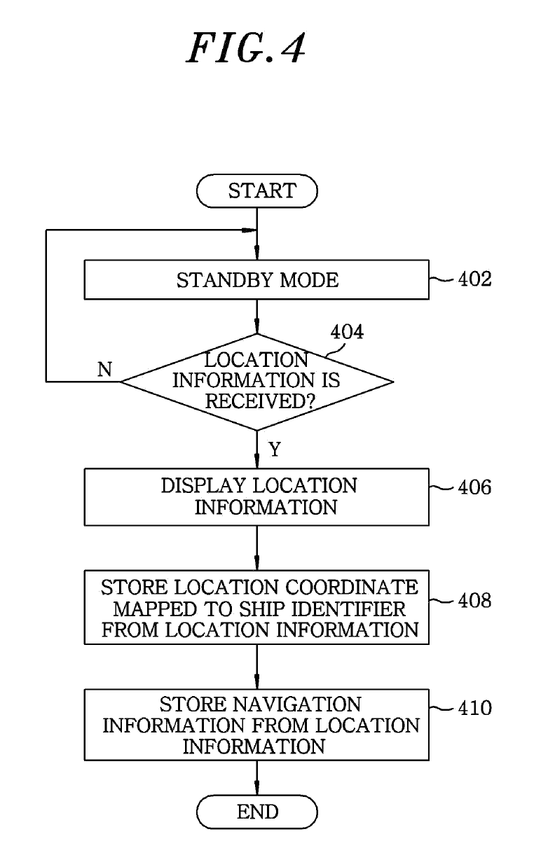

FIG. 4 is a flowchart showing a process for receiving ship location information being broadcasted in a prescribed cycle and processing the location information in accordance with the embodiment of the present invention.

First, the ship traffic control apparatus waits for receiving specific information in the prescribed cycle, in a standby mode in step 402. In the standby mode, the operation controller 102 checks whether the location information of other ships is received through the communication unit 112 in step 404.

If it is determined in step 404 that location information of another ship is received, the operation controller 102 provides the display unit 110 with a display control signal so that the display unit 110 creates video data by superimposing the location information on the related navigation chart to display the video data in step 406.

The operation controller 102 extracts a location coordinate (i.e., coordinate information of another ship) corresponding to a ship identifier from the location information of the another ship and provides the location coordinate to the ship identifier/location coordinate manager 106, and the ship identifier/location coordinate manager 106 stores and manages the coordinate information of the another ship corresponding to the ship identifier of the another ship in step 408.

In addition, the operation controller 102 extracts navigation information from the location information of the another ship, and stores and manages the extracted navigation information in the navigation information database 108 as navigation information of the corresponding ship in step 410.

Meanwhile, in the embodiment of the present invention, a case of transmitting and receiving location information between ships has been described, however, it is also possible to transmit the location information between ships and the control system, and for the control system to store and manage the location information.

Therefore, the embodiment of the present invention measures and detects a location coordinate of a certain ship in a prescribed cycle, after generating coordinate information by mapping between the location coordinate and a ship identifier, forms location information by mapping between the coordinate information and navigation information, and broadcasts the location information to other ships or the control system. Then, other ships or the control system receives the location information, displays the location information, and effectively stores and manages the information.

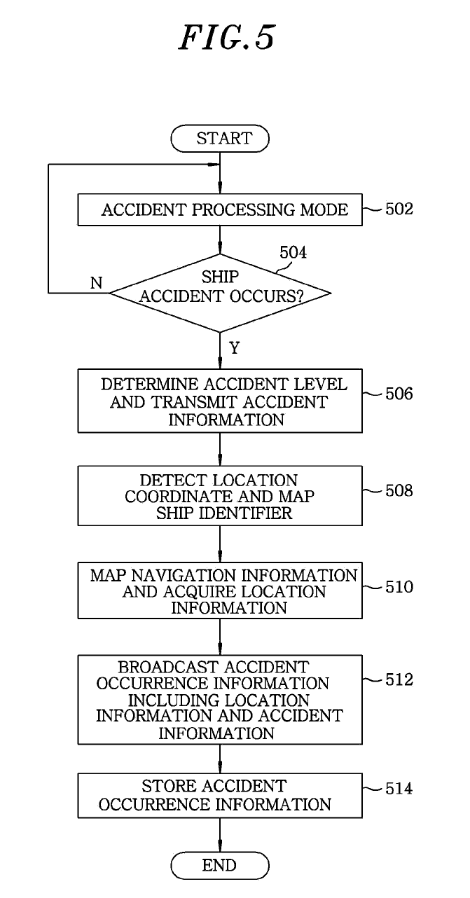

FIG. 5 is a flowchart showing a process for broadcasting accident occurrence information when a ship accident occurs, in accordance with the embodiment of the present invention.

First, the ship traffic control apparatus performs an accident processing mode in step 502. In the accident processing mode, the intelligent accident processing unit 114 checks whether the ship accident occurs in step 504.

If it is determined in step 504 that the accident occurs, the intelligent accident processing unit 114 determines a level of the accident by dividing the accident level into inoperable condition, slow speed-operable condition, medium speed-operable condition, normal operable condition, and the like, and transmits corresponding accident information to the operation controller 102 in step 506.

If the accident information is transmitted from the intelligent accident processing unit 114 to the operation controller 102, the operation controller 102 transmits location coordinate of the ship, which is measured by the location recognizer 104, to the ship identifier/location coordinate manager 106, and the ship identifier/location coordinate manager 106 maps the location coordinate to ship identifier information and transmits corresponding coordinate information to the operation controller 102 in step 508. If the coordinate information is transmitted from the ship identifier/location coordinate manager 106 to the operation controller 102, the operation controller 102 extracts navigation information, such as navigation chart, canal map, destination, departure location, speed, and the like from the navigation information database 108, maps the navigation information to the coordinate information and forms corresponding location information in step 510. Subsequently, the operation controller 102 forms accident occurrence information including the location information and the accident information and provides the communication unit 112 with a broadcast control signal for broadcasting the accident occurrence information to other ships, then, the communication unit 112 broadcasts the accident occurrence information to other ships and the control system in response to the broadcast control signal in step 512. The accident occurrence information may include, for example, navigation chart, canal map, destination, departure location, stopover place, speed, ship type, ship size, proprietary, ship ID, location coordinate, accident type, accident occurrence time, accident level, and measures for other ships against accident. That is, the accident occurrence information may include the location information and the accident information of the ship, and the location information may include coordinate information and navigation information of the ship.

The operation controller 102 stores and manages the accident occurrence information in the ship identifier/location coordinate manager 106 and the navigation information database 108 in step 514. In this case, the operation controller 102 may control the display unit 110 to display video data based on both the accident occurrence information and the navigation information.

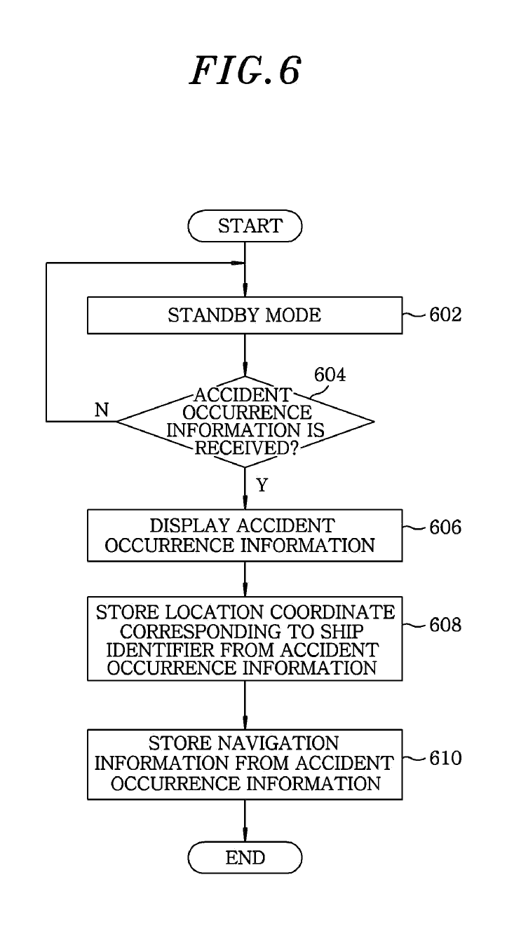

FIG. 6 is a flowchart showing a process for receiving accident occurrence information when an accident occurs and processing the accident occurrence information in accordance with the embodiment of the present invention.

First, the ship traffic control apparatus waits for receiving specific information in a prescribed cycle, in a standby mode in step 602. In the standby mode of the ship traffic control apparatus, the operation controller 102 checks whether the accident occurrence information of other ships is received through the communication unit 112 in step 604.

If it is determined in step 604 that the accident occurrence information of another ship is received, the operation controller 102 provides the display unit 110 a display control signal for displaying the accident occurrence information, and the display unit 110 displays video data by superimposing the accident occurrence information on the navigation chart, in response to the display control signal in step 606.

The operation controller 102 extracts the location coordinate (that is, coordinate information of the another ship) corresponding to the ship identifier from the accident occurrence information, and transmits the extracted location coordinate to the ship identifier/location coordinate manager 106, and the ship identifier/location coordinate manager 106 stores and manages the coordinate information corresponding to the ship identifier of the another ship in step 608.

The operation controller 102 extracts navigation information from the accident occurrence information, and stores and manages the extracted navigation information in the navigation information database 108 as navigation information of the corresponding ship in step 610.

Meanwhile, in the embodiment of the present invention, a case of transmitting and receiving the accident occurrence information between ships has been described, it is also possible to transmit the accident occurrence information between the ships and the control system. The control system may store and manage the accident occurrence information and transmit the accident occurrence information to other ships.

In accordance with the embodiment of the present invention, when an accident of a certain ship occurs, accident information is transmitted, coordinate information is formed by mapping between measured location coordinate and a ship identifier, location information is formed by mapping between the coordinate information and navigation information, and accident occurrence information including the location information and the accident information is broadcasted to other ships or the control system. Then, other ships or the control system receives and displays the accident occurrence information, and effectively stores and manages the information.

The present invention, unlike the conventional method which performs a ship operation by using Automatic Identification System (AIS), Single Side Band (SSB), or satellite communications depending on a ship type and a range of a navigation, may effectively provide a control service such as ship-collision prevention and operation control between ships or between ships and the control system, by broadcasting location information including location coordinate in a prescribed cycle, and, if there occurs a ship accident, broadcasting corresponding accident occurrence information to control the ship operation in response to the location information or the accident occurrence information.

In addition, cost for additional components such as radar equipments is reduced by using the satellite location-based service, and an accident may be prevented in advance by grasping location information of other ships and accident occurrence information in area with heavy traffic.

While the invention has been shown and described with respect to the embodiments, it will be understood by those skilled in the art that various changes and modification may be made without departing from the scope of the invention as defined in the following claims.

What is claimed is:

1. A ship traffic control apparatus comprising:
a location recognizer for measuring a location coordinate of a ship by using a satellite location-based service;
a ship identifier/location coordinate manager for storing the location coordinate as coordinate information corresponding to a ship identifier;
an accident processing unit for providing an accident information when an accident occurs; and
an operation controller for forming location information by mapping between the coordinate information and navigation information, transmitting the location information to other ships or a control system in a prescribed cycle through a radio communication unit, and transmitting accident occurrence information including the accident information and the location information to other ships or the control system.

2. The apparatus of claim 1, further comprising:
a navigation information database storing and managing the navigation information as a database, wherein the navigation information includes the location information or the accident information.

3. The apparatus of claim 1, further comprising:
a display unit for displaying the location information or the accident occurrence information as video data under control of the operation control unit.

4. The apparatus of claim 1, wherein the coordinate information includes a ship type, a ship size, proprietary, a ship ID, and the location coordinate.

5. The apparatus of claim 1, wherein the location information is formed by mapping between the coordinate information and the navigation information including a navigation chart and a canal map.

6. The apparatus of claim 1, wherein the accident occurrence information is formed on the basis of the location information and the accident information, wherein the accident information includes a type of the accident, an occurrence time of the accident, a level of the accident, and measures for other ships against the accident.

7. The apparatus of claim 1, wherein the radio communication unit is any one of a broad-band radio communication module and a VHF radio communication module.

8. A ship traffic control method comprising:
measuring a location coordinate of a ship in a prescribed cycle;
mapping the measured location coordinate to a ship identifier to form coordinate information;
mapping the coordinate information to navigation information to form location information of the ship; and
broadcasting the location information to other ships or a control system in a prescribed cycle through a radio communication unit.

9. The method of claim 8, further comprising:
checking whether an accident occurs while the location information is being broadcasted in the prescribed cycle;
if the accident occurs, forming accident occurrence information including accident information related to the accident and the location information; and
broadcasting the accident occurrence information to other ships or the control system through the radio communication unit.

10. The method of claim 8, further comprising:
receiving location information or accident occurrence information broadcasted from other ships or the control system in the prescribed cycle; and
storing and managing the location information or the accident occurrence information from other ships or the control system.

11. The method of claim 8, wherein the location information is formed on the basis of the location information including a ship type, a ship size, proprietary, a ship ID, and the location coordinate, and the navigation information including a navigation chart and a canal map.

12. The method of claim 8, wherein the accident occurrence information is formed on the basis of the location information and the accident information including a type of the accident, an occurrence time of the accident, a level of the accident, and measures for other ships against the accident.

13. The method of claim 8, wherein the radio communication unit is any one of a broad-band radio communication module and a VHF radio communication module.
